(19) United States
(12) Patent Application Publication
(10) Pub. No.: US 2026/0086390 A1
(43) Pub. Date: Mar. 26, 2026

(54) GLASSES FOR RELIEVING FATIGUE

(71) Applicant: SUZHOU PANCHUANG TECHNOLOGY CO., LTD, Suzhou (CN)

(72) Inventors: Jiaqi CHEN, Suzhou (CN); Haitan XU, Suzhou (CN); Lingyun XU, Suzhou (CN)

(73) Assignee: SUZHOU PANCHUANG TECHNOLOGY CO., LTD, Suzhou, JS (CN)

(21) Appl. No.: 19/409,955

(22) Filed: Dec. 5, 2025

Related U.S. Application Data
(63) Continuation-in-part of application No. PCT/CN2024/098023, filed on Jun. 7, 2024.

(30) Foreign Application Priority Data
Jun. 8, 2023 (CN) 2023214517821

(51) Int. Cl. G02C 7/02; G02C 1/06; G02C 5/02; G02C 5/12; G02C 5/20; G02C 5/22

(52) U.S. Cl. CPC G02C 7/022; G02C 1/06; G02C 5/02; G02C 5/12; G02C 5/20; G02C 5/2209

(57) ABSTRACT

Disclosed is a Fatigue-relieving glasses. The glasses includes a frame and a Fresnel lens element mounted on the frame. The Fresnel lens has a first lens surface and a second lens surface opposite to each other, the first lens surface is a Fresnel lens surface or a Fresnel prism surface, the second lens surface is a planar surface, a spherical surface, an aspherical surface, a cylindrical surface, a Fresnel lens surface, or a Fresnel prism surface, the Fresnel lens surface includes a plurality of concentrically arranged annular protrusions, and the Fresnel prism surface includes a plurality of linear protrusions arranged in parallel.

### CROSS REFERENCE TO RELATED APPLICATIONS

This application is a continuation-in-part application of PCT/CN2024/098023, filed on Jun. 7, 2024, which claims priority to Chinese Patent Application No. 202321451782.1, filed on Jun. 8, 2023, the entire contents of which are incorporated herein by reference.

### FIELD

The present disclosure relates to the technical field of glasses; for example, fatigue-relieving glasses.

### BACKGROUND

Glasses are a product including lenses and a frame, and used for improving vision, protecting eyes, or decoration. Glasses can correct various vision problems, including myopia, hyperopia, astigmatism, presbyopia, strabismus, or amblyopia. Using devices at a close distance, such as computers or mobile phones for a long time, will keep the eyes focused at a near distance, leading to eye fatigue. Alternatively, fatigue may result from the weight of the worn glasses pressing around the eyes. Therefore, there is a need to design a type of fatigue-relieving glasses. Patent No. CN210401878U discloses glasses convenient for relieving eye fatigue. Through the arrangement of a first cylinder, a second magnet, a first magnet, a clamping rod, and a second cylinder, the glasses are convenient for relieving eye fatigue allow for quick disassembly of the connection points, effectively improving the convenience of disassembly for cleaning dust. Through the arrangement of a first protective layer, a sheath, and a grease adsorption layer, the grease adhering to the surface of the glasses legs can be effectively absorbed, improving the user experience.

The above-mentioned patent does not disclose a technical solution for relieving eye fatigue. According to related art, common glasses for relieving fatigue generally adopt massage or fumigation methods. The overall structures of such glasses are relatively complex. Although they can achieve eye fatigue relief, their heavy weight imposes a significant burden when worn, making them difficult to promote.

### SUMMARY

The present disclosure provides fatigue-relieving glasses, which can relieve eye fatigue, are lightweight in design, simple in structure, and can reduce pressure.

An aspect of the present disclosure relates to fatigue-relieving glasses, including:

a frame; and

a Fresnel lens elements mounted on the frame;

wherein the Fresnel lens element has a first lens surface and a second lens surface opposite to each other, the first lens surface is a Fresnel lens surface or a Fresnel prism surface, the second lens surface is a planar surface, a spherical surface, an aspherical surface, a cylindrical surface, a Fresnel lens surface, or a Fresnel prism surface, the Fresnel lens surface includes a plurality of concentrically arranged annular protrusions, and the Fresnel prism surface includes a plurality of linear protrusions arranged in parallel.

In an embodiment, the Fresnel lens element includes a single lens, and the first lens surface and the second lens surface are respectively two side surfaces of the single lens.

In an embodiment, the Fresnel lens element includes:

a Fresnel lens having a Fresnel lens surface; and

a Fresnel prism having a Fresnel prism surface;

wherein the Fresnel lens and the Fresnel prism are attached to each other or spaced apart.

In an embodiment, the Fresnel lens element includes:

a Fresnel prism having a Fresnel prism surface; and

a spherical lens or an aspherical lens;

wherein the Fresnel prism and the spherical lens or the aspherical lens are attached to each other or spaced apart.

In an embodiment, the Fresnel lens element is configured to have a degree of causing scattered light from a near object to enter a wearer's eyes as parallel light, converged light, or divergent light, and the glasses are configured such that an actual interpupillary distance when the wearer views a near object is greater than an interpupillary distance when viewing the near object with naked eyes. In an embodiment, a distance between the near object and the wearer's glasses is less than 1 meter.

In an embodiment, the frame includes:

two rims, wherein Fresnel lens elements are mounted inside the two rims;

a bridge connected between tops of the two rims;

a plurality of nose pads disposed at bottoms of the two rims or on the bridge;

two movable brackets connected to the two rims, wherein the two rims are located between the two movable brackets; and

two legs, each connected to one of the movable brackets.

An embodiment of fatigue-relieving glasses includes two rims, wherein Fresnel lens elements are mounted inside the two rims, a bridge is connected between tops of the two rims, nose pads are disposed on bottom outer walls between the two rims near both ends of the bridge, movable brackets are movably connected to outer ends of the two rims facing away from each other respectively, a leg is movably connected to an end of each movable bracket, and a rotating mechanism is provided between each movable bracket and the respective corresponding leg.

In an embodiment, the Fresnel lens element is an integrated lens structure including a Fresnel prism and a Fresnel lens.

In an embodiment, the Fresnel lens element is a lens structure formed by attaching a Fresnel prism and a Fresnel lens to each other.

In an embodiment, the Fresnel lens element is a lens structure formed by attaching a Fresnel prism onto a lens.

In an embodiment, both ends of the bridge are welded on outer walls of the two rims, each nose pad is fixedly connected to the outer wall of one respective corresponding rim by a screw, and a silicone pad is provided on an inner surface of each nose pad.

In an embodiment, a hinge is connected between each movable bracket and the outer wall of one respective corresponding rim, and the movable bracket is rotatably connected to the respective corresponding rim via the hinge.

In an embodiment, the rotating mechanism includes a connecting bracket fixedly connected to an inner side wall of the movable bracket and a fixing base fixedly connected to an inner side wall of the leg, wherein one end of the fixing base is provided with a rotating block extending into the interior of the connecting bracket, and a rotating shaft is connected between the rotating block and the connecting bracket.

In an embodiment, the connecting bracket is fixed to the inner side wall of the movable bracket by welding, and the fixing base is fixed to the inner side wall of the leg by welding.

In an embodiment, a bearing seat is provided on an inner wall of the connecting bracket corresponding to a position of an end of the rotating block.

In an embodiment, a degree of the Fresnel lens element is capable of causing scattered light from a near object to enter a wearer's eyes as parallel light, converged light, or divergent light, and the glasses cause an actual interpupillary distance when the wearer views a near object to be greater than or equal to an interpupillary distance when viewing the near object with naked eyes.

### BRIEF DESCRIPTION OF THE DRAWINGS

FIG. 1 is a schematic structural diagram of an embodiment according to the present disclosure;

FIG. 2 is an enlarged view of part A in FIG. 1 of an embodiment according to the present disclosure;

FIG. 3 is a schematic structural diagram of a Fresnel lens element according to an embodiment of the present disclosure;

FIG. 4 is a schematic structural diagram of another Fresnel lens element according to an embodiment of the present disclosure;

FIG. 5 is a schematic structural diagram of yet another Fresnel lens element according to an embodiment of the present disclosure;

FIG. 6 is a schematic diagram of a Fresnel lens surface according to an embodiment of the present disclosure;

FIG. 7 is a schematic diagram of a Fresnel prism surface according to an embodiment of the present disclosure.

Reference signs: 1—Rim; 2—Fresnel lens element; 3—Bridge; 4—Nose pad; 5—Movable bracket; 6—Hinge; 7—Leg; 8—Leg tip; 9—Connecting bracket; 10—Fixing base; 11—Rotating block; 12—Rotating shaft; 13—Bearing seat; 201—Fresnel lens; 202—Fresnel prism; 203—Lens; 204—Annular protrusion; 205—Linear protrusion.

### DETAILED DESCRIPTION

The embodiments of the present disclosure will be described below with reference to the drawings in the embodiments of the present disclosure. The described embodiments are some of the embodiments related to the present disclosure, rather than all of the embodiments. Based on the embodiments in the present disclosure, all other embodiments obtained by a person of ordinary skill in the art without creative efforts shall fall within the protection scope of the present disclosure.

Examples provide fatigue-relieving glasses including a frame and Fresnel lens elements 2. The Fresnel lens elements 2 are mounted on the frame. The Fresnel lens element 2 has a first lens surface and a second lens surface opposite to each other. The first lens surface is a Fresnel lens surface or a Fresnel prism surface. The second lens surface is a planar surface, a spherical surface, an aspherical surface, a cylindrical surface, a Fresnel lens surface, or a Fresnel prism surface. The Fresnel lens surface includes a plurality of concentrically arranged annular protrusions 204, and the Fresnel prism surface includes a plurality of linear protrusions 205 arranged in parallel. In an embodiment, viewed from the perspective of a wearer, the first lens surface faces forward, and the second lens surface faces backward; in another embodiment, the first lens surface faces backward, and the second lens surface faces forward. Herein, a “spherical surface” is a part of a round sphere; an “aspherical surface” is a curved surface where the central part arches forward or backward relative to its peripheral edge along a center line (e.g., a straight line in the front-rear direction passing through the center of the lens), and curvatures at at least two locations on the aspherical surface are different; a “cylindrical surface”is a part of a side surface of a cylinder.

The frame may include the rims 1, bridge 3, nose pads 4, movable brackets 5, hinges 6, legs 7, and leg tips 8 described below. The specific structure of the glasses will be described below in conjunction with the drawings.

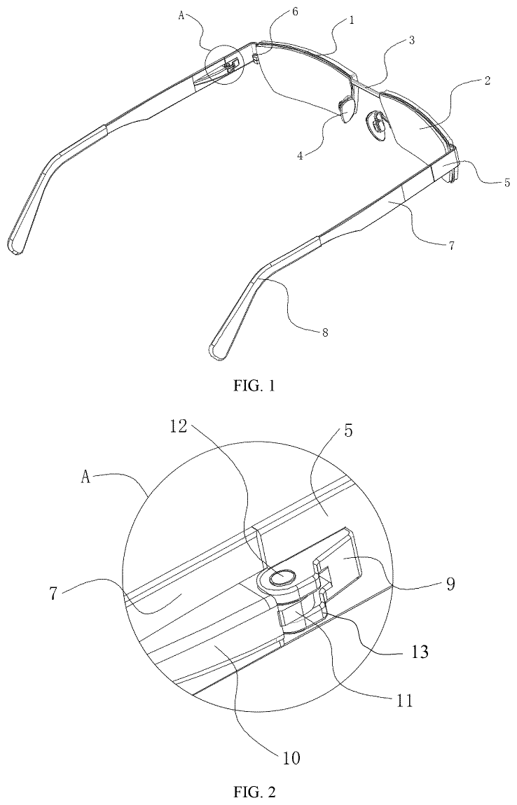

As shown in FIGS. 1 to 3, fatigue-relieving glasses include two rims 1. Fresnel lens elements 2 are mounted inside both rims 1, and a bridge 3 is connected between tops of the two rims 1. Nose pads 4 are disposed on bottom outer walls between the two rims 1 near both ends of the bridge 3. Movable brackets 5 are movably connected to outer ends of the two rims 1 facing away from each other, respectively. A leg 7 is movably connected to an end of each movable bracket 5. A leg tip 8 placed on the ear is sleeved on an end of each leg 7. A rotating mechanism is provided between each movable bracket 5 and the respective corresponding leg 7.

In some embodiments, the Fresnel lens element 2 is an integrated lens structure including a Fresnel prism 202 and a Fresnel lens 201.

In some embodiments, the connection between both ends of the bridge 3 and outer walls of the two rims 1 is welding. Each nose pad 4 is fixedly connected to the outer wall of the respective corresponding rim 1 by a screw, and a silicone pad is provided on an inner surface of each nose pad 4.

In some embodiments, a hinge 6 is connected between each movable bracket 5 and the outer wall of the respective corresponding rim 1, and the movable bracket 5 is rotatably connected to the rim 1 via the hinge 6. In other embodiments, the movable bracket 5 and the rim 1 are directly fixed or form an integrated single part.

In some embodiments, the rotating mechanism includes a connecting bracket 9 fixedly connected to an inner side wall of the movable bracket 5 and a fixing base 10 fixedly connected to an inner side wall of the leg 7. One end of the fixing base 10 is provided with a rotating block 11 extending into the interior of the connecting bracket 9. A rotating shaft 12 is connected between the rotating block 11 and the connecting bracket 9. The connecting bracket 9 is fixed to the inner side wall of the movable bracket 5 by welding, and the fixing base 10 is fixed to the inner side wall of the leg 7 by welding. A bearing seat 13 is provided on an inner wall of the connecting bracket 9 corresponding to a position of an end of the rotating block 11.

In some embodiments, a degree of the Fresnel lens element 2 is a power capable of causing scattered light from a near object to enter a wearer's eyes as parallel light, converged light, or divergent light, and the glasses cause an actual interpupillary distance when the wearer views a near object to be greater than or equal to an interpupillary distance when viewing the near object with naked eyes.

As shown in FIGS. 1 to 2 and FIG. 4, fatigue-relieving glasses include two rims 1. Fresnel lens elements 2 are mounted inside both rims 1, and a bridge 3 is connected between tops of the two rims 1. Nose pads 4 are disposed on bottom outer walls between the two rims 1 near both ends of the bridge 3. Movable brackets 5 are movably connected to outer ends of the two rims 1 facing away from each other, respectively. A leg 7 is movably connected to an end of each movable bracket 5. A leg tip 8 placed on the ear is sleeved on an end of each leg 7. A rotating mechanism is provided between each movable bracket 5 and the respective corresponding leg 7.

In some embodiments, the Fresnel lens element 2 is a lens structure in which an independent Fresnel prism 202 and an independent Fresnel lens 201 are attached together.

In some embodiments, the connection manner between both ends of the bridge 3 and outer walls of the two rims 1 is welding. Each nose pad 4 is fixedly connected to the outer wall of the respective corresponding rim 1 by a screw, and a silicone pad is provided on an inner surface of each nose pad 4.

In some embodiments, a hinge 6 is connected between each movable bracket 5 and the outer wall of the respective corresponding rim 1, and the movable bracket 5 is rotatably connected to the rim 1 via the hinge 6.

In some embodiments, the rotating mechanism includes a connecting bracket 9 fixedly connected to an inner side wall of the movable bracket 5 and a fixing base 10 fixedly connected to an inner side wall of the leg 7. One end of the fixing base 10 is provided with a rotating block 11 extending into the interior of the connecting bracket 9. A rotating shaft 12 is connected between the rotating block 11 and the connecting bracket 9. The connecting bracket 9 is fixed to the inner side wall of the movable bracket 5 by welding, and the fixing base 10 is fixed to the inner side wall of the leg 7 by welding. A bearing seat 13 is provided on an inner wall of the connecting bracket 9 corresponding to a position of an end of the rotating block 11.

In some embodiments, a degree of the Fresnel lens element 2 is a power capable of causing scattered light from a near object to enter a wearer's eyes as parallel light, converged light, or divergent light, and the glasses cause an actual interpupillary distance when the wearer views a near object to be greater than or equal to an interpupillary distance when viewing the near object with naked eyes.

As shown in FIGS. 1 to 2 and FIG. 5, fatigue-relieving glasses include two rims 1. Fresnel lens elements 2 are mounted inside both rims 1, and a bridge 3 is connected between tops of the two rims 1. Nose pads 4 are disposed on bottom outer walls between the two rims 1 near both ends of the bridge 3. Movable brackets 5 are movably connected to outer ends of the two rims 1 facing away from each other, respectively. A leg 7 is movably connected to an end of each movable bracket 5. A leg tip 8 placed on the ear is sleeved on an end of each leg 7. A rotating mechanism is provided between each movable bracket 5 and the respective corresponding leg 7.

In some embodiments, the Fresnel lens element 2 is a lens structure in which a Fresnel prism 202 and a type of lens 203 are attached together, wherein the lens 203 may be a conventional lens.

In some embodiments, the connection between both ends of the bridge 3 and outer walls of the two rims 1 is welding. Each nose pad 4 is fixedly connected to the outer wall of the respective corresponding rim 1 by a screw, and a silicone pad is provided on an inner surface of each nose pad 4.

In some embodiments, a hinge 6 is connected between each movable bracket 5 and the outer wall of the respective corresponding rim 1, and the movable bracket 5 is rotatably connected to the rim 1 via the hinge 6.

In some embodiments, the rotating mechanism includes a connecting bracket 9 fixedly connected to an inner side wall of the movable bracket 5 and a fixing base 10 fixedly connected to an inner side wall of the leg 7. One end of the fixing base 10 is provided with a rotating block 11 extending into the interior of the connecting bracket 9. A rotating shaft 12 is connected between the rotating block 11 and the connecting bracket 9. The connecting bracket 9 is fixed to the inner side wall of the movable bracket 5 by welding, and the fixing base 10 is fixed to the inner side wall of the leg 7 by welding. A bearing seat 13 is provided on an inner wall of the connecting bracket 9 corresponding to a position of an end of the rotating block 11.

In some embodiments, a degree of the Fresnel lens element 2 is a power capable of causing scattered light from a near object to enter a wearer's eyes as parallel light, converged light, or divergent light, and the glasses cause an actual interpupillary distance when the wearer views a near object to be greater than or equal to an interpupillary distance when viewing the near object with naked eyes.

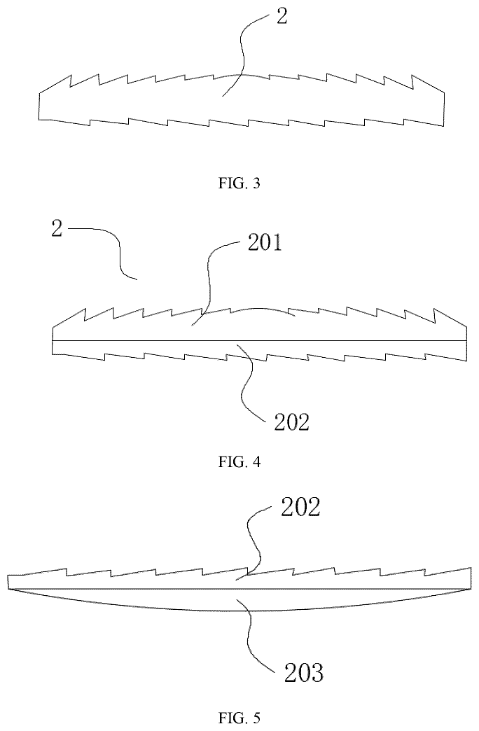

As shown in FIG. 3, the Fresnel lens element 2 is an integrated lens structure integrating a Fresnel prism 202 and a Fresnel lens 201. That is, the Fresnel lens element 2 includes a single lens, and two side surfaces of the single lens serve as the first lens surface and the second lens surface, respectively. The first lens surface is the Fresnel lens surface of the Fresnel lens 201, and the second lens surface is the Fresnel prism surface of the Fresnel prism 202.

As shown in FIG. 4, the Fresnel lens element 2 is a lens structure in which an independent Fresnel prism 202 and an independent Fresnel lens 201 are attached together. That is, the Fresnel lens element 2 includes: a Fresnel lens 201 having a Fresnel lens surface and a Fresnel prism 202 having a Fresnel prism surface. The Fresnel lens 201 and the Fresnel prism 202 are attached to each other and are configured such that the Fresnel lens surface and the Fresnel prism surface are exposed to constitute the front and rear lens surfaces of the Fresnel lens element 2. In some other embodiments, the Fresnel lens 201 and the Fresnel prism 202 may not be in contact, but are spaced apart along the front-rear direction.

As shown in FIG. 5, the Fresnel lens element 2 is a lens structure in which a Fresnel prism 202 and a lens 203 are attached together. That is, the Fresnel lens element 2 includes a Fresnel prism 202 having a Fresnel prism surface and a spherical lens 203 having a spherical surface. The Fresnel prism 202 and the spherical lens 203 are attached to each other and are configured such that the Fresnel prism surface and the spherical surface are exposed to constitute the front and rear lens surfaces of the Fresnel lens element 2. In some other embodiments, the Fresnel lens 201 and the Fresnel prism 202 may not be in contact, but are spaced apart along the front-rear direction.

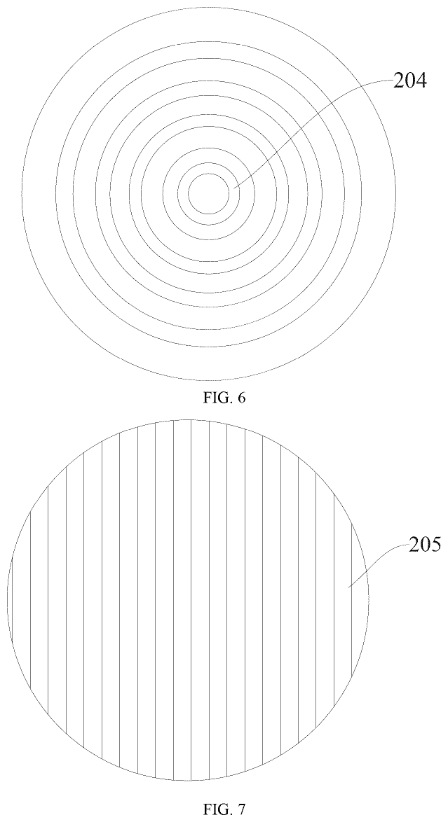

The structure of the Fresnel lens surface can be seen in FIGS. 3, 4, and 6, which has a plurality of concentrically arranged annular protrusions 204. The structure of the Fresnel prism surface can be seen in FIGS. 3 to 5 and 7, which has a plurality of linear protrusions 205 arranged in parallel. If the Fresnel lens surface serves as the lens surface facing forward, the annular protrusions 204 protrude forward; conversely, if the Fresnel lens surface serves as the lens surface facing backward, the annular protrusions 204 protrude backward. Similarly, if the Fresnel prism surface serves as the lens surface facing forward, the linear protrusions 205 protrude forward; conversely, if the Fresnel prism surface serves as the lens surface facing backward, the linear protrusions 205 protrude backward.

Although having different structural designs, in actual use, all can achieve causing scattered light from a near object to approximately become parallel light entering the eyes through refraction by the Fresnel lens element while increasing the actual interpupillary distance when viewing a near object, thereby making the state of the eyes when viewing a near object equivalent to a relaxed state when viewing a distance. Moreover, the glasses are designed to be lightweight, simple in structure, and reduce pressure, thereby achieving the effect of relieving eye fatigue. Considering that when human eyes are completely relaxed, the interpupillary distance is even larger than when viewing a distance, the power of the Fresnel prism 202 can be increased to achieve a completely relaxed state and reduce fatigue. The distance between the near object and the wearer's glasses is less than 1 meter. When the wearer observes an object within 1 meter, the glasses can make the state of the eyes equivalent to the relaxed state when viewing a distance, achieving the effect of relieving eye fatigue.

In the drawings of the embodiments disclosed herein, only the structures described in the embodiments of the present disclosure are involved, and other structures can refer to conventional designs.

What is claimed is:

1. A fatigue-relieving glasses comprising:
a frame; and
a Fresnel lens element mounted on the frame;
wherein the Fresnel lens includes a first lens surface and a second lens surface opposite to each other, the first lens surface is a Fresnel lens surface or a Fresnel prism surface, the second lens surface is a planar surface, a spherical surface, an aspherical surface, a cylindrical surface, a Fresnel lens surface, or a Fresnel prism surface, the Fresnel lens surface includes a plurality of concentrically arranged annular protrusions, and the Fresnel prism surface includes a plurality of linear protrusions arranged in parallel.

2. The fatigue-relieving glasses of claim 1, wherein the Fresnel lens element comprises a single lens, and the first lens surface and the second lens surface are respectively two side surfaces of the single lens.

3. The fatigue-relieving glasses of claim 1, wherein the Fresnel lens element comprises:
a Fresnel lens having a Fresnel lens surface; and
a Fresnel prism having a Fresnel prism surface;
wherein the Fresnel lens and the Fresnel prism are attached to each other or spaced apart.

4. The fatigue-relieving glasses of claim 1, wherein the Fresnel lens element comprises:
a Fresnel prism having a Fresnel prism surface; and
a spherical lens or an aspherical lens;
wherein the Fresnel prism and the spherical lens or the aspherical lens are attached to each other or spaced apart.

5. The fatigue-relieving glasses of claim 1, wherein the Fresnel lens element is configured to have a degree of causing scattered light from a near object to enter a wearer's eyes as parallel light, converged light, or divergent light, and the glasses are configured such that an actual interpupillary distance when the wearer views a near object is greater than an interpupillary distance when viewing the near object with naked eyes.

6. The fatigue-relieving glasses of claim 5, wherein a distance between the near object and the wearer's glasses is less than 1 meter.

7. The fatigue-relieving glasses of claim 1, wherein the frame comprises:
two rims, wherein Fresnel lens elements are mounted inside the two rims;
a bridge connected between tops of the two rims;
a plurality of nose pads disposed at bottoms of the two rims or on the bridge;
two movable brackets connected to the two rims, wherein the two rims are located between the two movable brackets; and
two legs, each connected to one of the movable brackets.

8. A fatigue-relieving glasses comprising:
two rims, wherein Fresnel lens elements are mounted inside the two rims,
a bridge is connected between tops of the two rims,
nose pads are disposed on bottom outer walls between the two rims near both ends of the bridge,
movable brackets are movably connected to outer ends of the two rims facing away from each other respectively,
a leg is movably connected to an end of each movable bracket, and
a rotating mechanism is provided between each movable bracket and the respective corresponding leg.

9. The fatigue-relieving glasses of claim 8, wherein the Fresnel lens element is an integrated lens structure comprising a Fresnel prism and a Fresnel lens.

10. The fatigue-relieving glasses of claim 8, wherein the Fresnel lens element is a lens structure formed by attaching a Fresnel prism and a Fresnel lens to each other.

11. The fatigue-relieving glasses of claim 8, wherein the Fresnel lens element is a lens structure formed by attaching a Fresnel prism onto another lens.

12. The fatigue-relieving glasses of claim 8, wherein both ends of the bridge are welded on outer walls of the two rims, each nose pad is fixedly connected to the outer wall of one corresponding rim by a screw, and a silicone pad is provided on an inner surface of each nose pad.

13. The fatigue-relieving glasses of claim 8, wherein each movable bracket and the outer wall of one respective corresponding rim are connected by a hinge, and the movable bracket is rotatably connected to the respective corresponding rim via the hinge.

14. The fatigue-relieving glasses of claim 8, wherein the rotating mechanism comprises:
a connecting bracket fixedly connected to an inner side wall of the movable bracket; and
a fixing base fixedly connected to an inner side wall of the leg,
wherein one end of the fixing base is provided with a rotating block extending into the interior of the connecting bracket, and a rotating shaft is connected between the rotating block and the connecting bracket.

15. The fatigue-relieving glasses of claim 14, wherein the connecting bracket is fixed to the inner side wall of the movable bracket by welding, and the fixing base is fixed to the inner side wall of the leg by welding.

16. The fatigue-relieving glasses of claim 14, wherein a bearing seat is provided on an inner wall of the connecting bracket corresponding to a position of an end of the rotating block.

17. The fatigue-relieving glasses of claim 8, wherein a degree of the Fresnel lens element is capable of causing scattered light from a near object to enter a wearer's eyes as parallel light, converged light, or divergent light, and the fatigue-relieving glasses cause an actual interpupillary distance when the wearer views a near object to be greater than or equal to an interpupillary distance when viewing the near object with naked eyes.
